(19) United States
(12) Patent Application Publication
(10) Pub. No.: US 2025/0269761 A1
(43) Pub. Date: Aug. 28, 2025

(54) INFORMATION PROVIDING SYSTEM

(71) Applicant: TOYOTA JIDOSHA KABUSHIKI KAISHA, Toyota-shi (JP)

(72) Inventors: Kenji ZAITSU, Nagoya-shi (JP); Hiroshi YAMASAKI, Nagoya-shi (JP); Masahiro KAGAMI, Nagoya-shi (JP); Yasuhide KURIMOTO, Kasugai-shi (JP)

(73) Assignee: TOYOTA JIDOSHA KABUSHIKI KAISHA, Toyota-shi (JP)

(21) Appl. No.: 18/933,126

(22) Filed: Oct. 31, 2024

(30) Foreign Application Priority Data
Feb. 26, 2024 (JP) 2024-026827

(51) Int. Cl. B60L 58/10; G06Q 30/0283

(52) U.S. Cl. CPC B60L 58/10; G06Q 30/0283

(57) ABSTRACT

An information providing system is a system that provides carbon footprint information of a battery pack mounted on a vehicle and includes one or more processors. The one or more processors are configured to acquire the carbon footprint information including first CO₂ emission amount information and second CO₂ emission amount information, the first CO₂ emission amount information being obtained by converting an amount of emission of greenhouse gas concerned with manufacturing the battery pack and the vehicle into a CO₂ emission amount, the second CO₂ emission amount information being obtained by converting an amount of emission of greenhouse gas emitted during primary use of the battery pack in the vehicle into a CO₂ emission amount, and provide a requester with the carbon footprint information in response to a request from the requester.

### CROSS-REFERENCE TO RELATED APPLICATION

This application claims priority to Japanese Patent Application No. 2024-026827 filed on Feb. 26, 2024, incorporated herein by reference in its entirety.

### BACKGROUND

### 1. Technical Field

The disclosure relates to an information providing system that provides carbon footprint information of an in-vehicle battery pack.

### 2. Description of Related Art

Japanese Unexamined Patent Application Publication No. 2010-254053 (JP 2010-254053 A) describes a greenhouse gas emission display device mounted on a vehicle including different types of driving sources. Japanese Unexamined Patent Application Publication No. 2014-215773 (JP 2014-215773 A) describes a technology to estimate the amount of emission of greenhouse gas emitted from electronic media, such as electronic books, and an information communication device used to browse or reproduce the electronic media. Furthermore, Japanese Unexamined Patent Application Publication No. 2011-123670 (JP 2011-123670 A) describes a greenhouse gas emissions rights trading system.

### SUMMARY

As for battery packs that are estimated to be reused after primary use in vehicles, information on the amount of emission of greenhouse gas emitted during the time from resource mining to primary use is worth for people that are interested in the battery packs, that is, users and other people that reuse battery packs. For this reason, it is important to keep track of the amount of emission and get ready to provide the amount of emission.

An information providing system according to the disclosure is a system that provides carbon footprint information of a battery pack mounted on a vehicle and includes one or more processors. The one or more processors are configured to acquire the carbon footprint information including first CO₂ emission amount information and second CO₂ emission amount information, the first CO₂ emission amount information being obtained by converting an amount of emission of greenhouse gas concerned with manufacturing the battery pack and the vehicle into a CO₂ emission amount, the second CO₂ emission amount information being obtained by converting an amount of emission of greenhouse gas emitted during primary use of the battery pack in the vehicle into a CO₂ emission amount, and provide a requester with the carbon footprint information in response to a request from the requester.

With the information providing system according to the disclosure, it is possible to provide information on the amount of emission of greenhouse gas concerned with an in-vehicle battery pack as carbon footprint information.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram for illustrating a general outline of a battery reuse management system according to an embodiment;

FIG. 2 is a conceptual diagram for illustrating information related to the reuse of a battery pack;

FIG. 3 is a diagram that shows processes P1, P2, P3, P4, P5, P6, and P7 related to a battery pack;

FIG. 4 is a block diagram that shows the functional configuration of a first example related to acquisition and provision of CFP information;

FIG. 5 is a block diagram that shows the functional configuration of a second example related to acquisition and provision of CFP information; and

FIG. 6 is a block diagram that shows the functional configuration of a third example related to acquisition and provision of CFP information.

### DETAILED DESCRIPTION OF EMBODIMENTS

An embodiment of the disclosure will be described with reference to the accompanying drawings.

### 1. Battery Reuse Management System

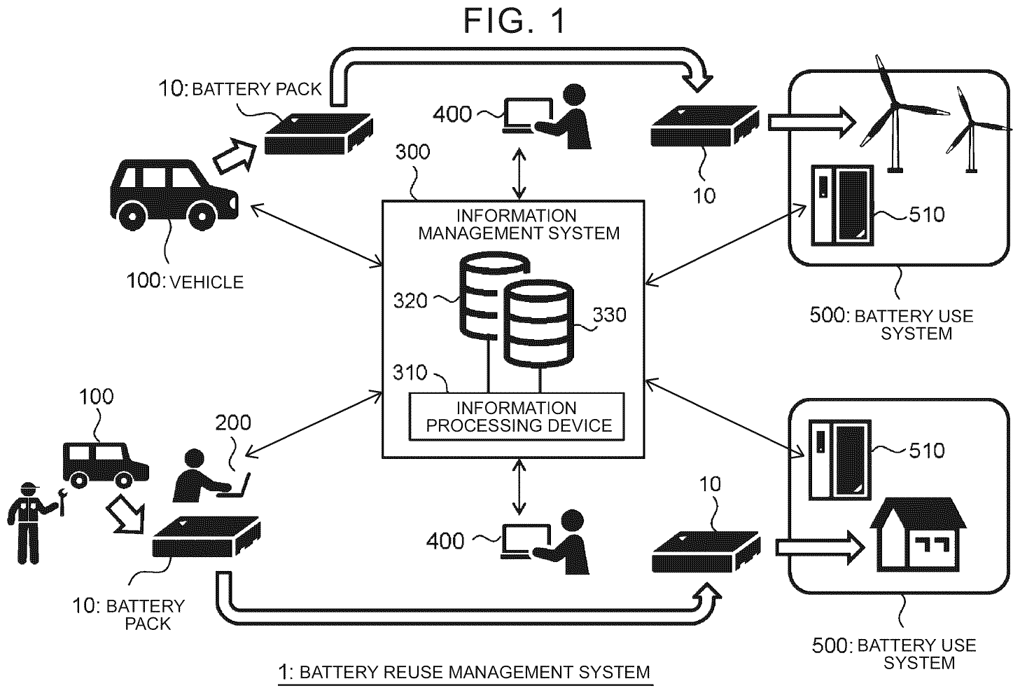

FIG. 1 is a conceptual diagram for illustrating a general outline of a battery reuse management system 1 according to the present embodiment. The battery reuse management system 1 manages the reuse of a battery pack 10. Reuse is a concept including secondary use, tertiary use, . . . . Particularly, the battery reuse management system 1 manages the reuse of the battery pack (in-vehicle battery pack) 10 mounted on a vehicle 100. The vehicle 100 is, for example, a battery electric vehicle (BEV) that uses an electric motor as a driving power unit. Alternatively, the vehicle 100 may be, for example, a plug-in hybrid electric vehicle (PHEV) that uses an electric motor and an internal combustion engine as driving power units and that allows the battery pack 10 to be charged from an outside source. The battery pack 10 is mounted on the vehicle 100. The electric motor is driven by electric power supplied from the battery pack 10.

The battery reuse management system 1 includes one or more vehicles 100 and an information management system 300. The information management system 300 serves as an information platform that manages various pieces of information. The information management system 300 includes one or more servers. The information management system 300 may be made up of a plurality of servers that perform distributed processing. Each vehicle 100 and the information management system 300 can communicate with each other via a wireless communication network.

More specifically, the information management system 300 includes an information processing device 310. The information processing device 310 stores various pieces of information, executes various pieces of information processing, and communicates with external sources via a communication interface. The information processing device 310 includes one or more processors and one or more storage devices. The functions of the information processing device 310 may be implemented by cooperation of the processor(s) running a control program with the storage device(s). The control program is stored in the storage device(s). Alternatively, the control program may be recorded on a computer-readable recording medium. The information processing device 310 may be called processing circuitry.

The vehicle 100 may periodically transmit vehicle information on the vehicle 100 to the information management system 300. The vehicle information may include travel history information TRV indicating the travel history of the vehicle 100. For example, the travel history information TRV includes a total travel distance of the vehicle 100. In another example, the travel history information TRV may include location history information of the vehicle 100. The location of the vehicle 100 may be expressed by a combination of latitude and longitude.

The vehicle information may include battery information BAT reflecting a usage history of the battery pack 10. For example, the battery information BAT includes battery usage history information. The battery usage history information includes at least one of a temperature history, a state-of-charge (SOC) history, a current history, a voltage history, a charge history, and the like. Each history may be expressed by a frequency distribution. The battery information BAT may include a state of health (SOH). The SOH may be calculated based on battery usage history information. The battery information BAT may include a total charge electricity amount and/or a total discharge electricity amount or may include a total amount of charging power and/or a total amount of discharging power. The battery information BAT may include a battery capacity and/or a battery output.

The battery reuse management system 1 may further include a terminal 200 that is used at a vehicle dealer or a vehicle repair factory. At a vehicle dealer or a vehicle repair factory, the above-described vehicle information can be read from the vehicle 100 with a predetermined tool. The vehicle information read from the vehicle 100 is input to the terminal 200. In other words, the terminal 200 can also acquire the vehicle information. The terminal 200 is communicable with the information management system 300 via a wireless or wired communication network. The terminal 200 may transmit vehicle information read from the vehicle 100 to the information management system 300.

The information management system 300 collects, accumulates, and manages vehicle information on a large number of vehicles 100. The information management system 300 includes a vehicle information database 320 that accumulates vehicle information on a large number of vehicles 100. The vehicle information database 320 is implemented by one or more storage devices.

Next, the reuse of the battery packs 10 that have been mounted on the vehicles 100 will be described. The battery packs 10 are taken out from the vehicles 100 and reused.

A battery use system 500 is a system that uses a storage battery. For example, the battery use system 500 is a stationary storage battery system that accumulates renewable energy in a stationary storage battery. In another example, the battery use system 500 may be a home power supply system using a stationary storage battery. According to the present embodiment, the battery packs 10 that have been mounted on the vehicles 100 are reused in such a battery use system 500. A large number of battery packs 10 are provided from a large number of vehicles 100, so cost reduction of the battery use system 500 is facilitated, and proliferation of the battery use system 500 is facilitated. Then, the use of renewable energy is facilitated, so CO₂ emission is also reduced.

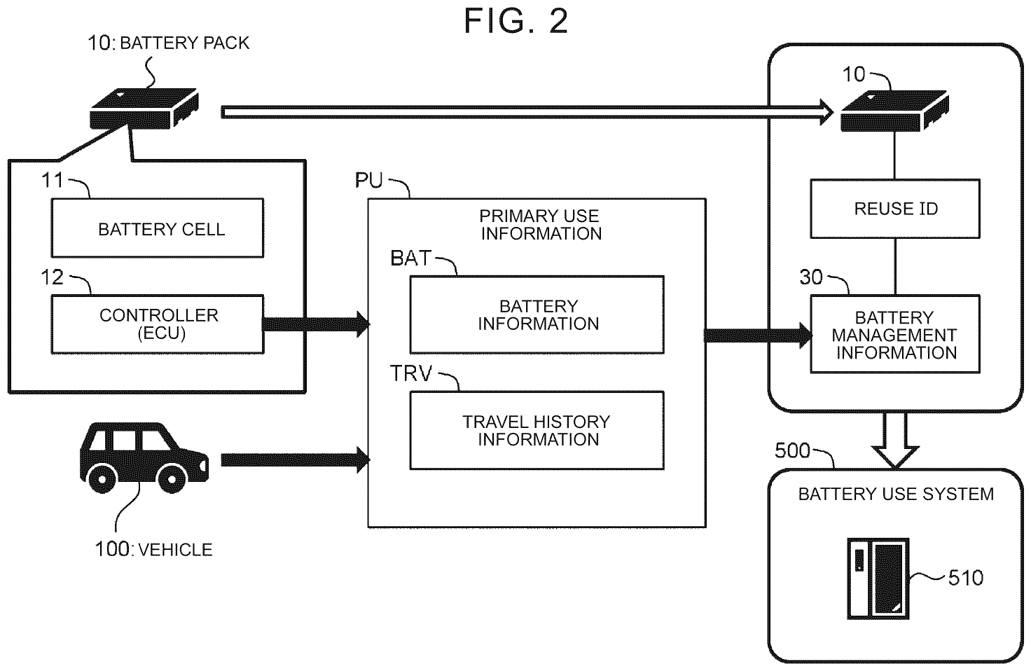

FIG. 2 is a conceptual diagram for illustrating information related to the reuse of a battery pack 10. The battery pack 10 includes one or more battery cells 11 and a controller 12 for controlling the battery pack 10. The controller 12 is also called electronic 15 control unit (ECU).

In reusing the battery pack 10, the battery reuse management system 1 acquires primary use information PU. The primary use information PU corresponds to vehicle information when the battery pack 10 is primarily used in the vehicle 100.

For example, the primary use information PU includes battery information BAT reflecting the usage history of the battery pack 10 primarily used in the vehicle 100. The battery information BAT is stored in the controller 12 (ECU) in the battery pack 10 and is read from the controller 12. For example, just before the battery pack 10 is taken out from the vehicle 100, an information processing device of the vehicle 100 acquires the battery information BAT from the controller 12 in the battery pack 10 and transmits the battery information BAT to the information management system 300.

The primary use information PU may include travel history information TRV of the vehicle 100 on which the battery pack 10 has been mounted. The travel history information TRV indicates at least one of the total travel distance and location history information of the vehicle 100. The total travel distance is stored in the controller 12 in the battery pack 10 or a storage device of an in-vehicle system. The location history information is obtained from the storage device of the in-vehicle system or the vehicle information database 320 of the information management system 300. The information management system 300 acquires the travel history information TRV with a method similar to the method of acquiring the battery information BAT.

Battery management information 30 is information that is used when the battery pack 10 is reused. The battery management information 30 is generated based on the primary use information PU. More specifically, the battery management information 30 includes the battery information BAT and the travel history information TRV. There are various environments (ambient temperature, humidity, and the like) of regions where the vehicle 100 has travelled, and the degradation condition of battery performance varies depending on an environment, so the travel history information TRV can also be useful information when the battery pack 10 is reused. The battery management information 30 may include the vehicle type of the vehicle 100 on which the battery pack 10 has been mounted. The battery management information 30 may be generated in any one of the vehicle 100, the terminal 200, and the information management system 300.

The information management system 300 collects, accumulates, and manages pieces of battery management information 30 on a large number of vehicles 100. The information management system 300 includes a battery management information database 330 that accumulates the pieces of battery management information 30 on a large number of vehicles 100 (see FIG. 1). The battery management information database 330 is implemented by one or more storage devices.

Reuse identification information (hereinafter, referred to as “reuse ID”) is identification information of the battery pack 10 reused. The reuse ID is associated with the battery pack 10. The information processing device of the vehicle 100 associates the reuse ID with the primary use information PU or the battery management information 30 and transmits the reuse ID and the primary use information PU or the battery management information 30 to the information management system 300. In this way, the information management system 300 acquires the reuse ID and the battery management information of the battery pack 10. The information management system 300 associates the reuse ID with the battery management information 30 in the battery management information database 330. In other words, the information management system 300 manages the reuse ID and the battery management information 30 in association with each other.

The battery pack 10 taken out from the vehicle 100 is provided to a user that reuses the battery pack 10 (hereinafter, referred to as “reuse user” or “reuser”). The reuse user is an operator of the battery use system 500. The information management system 300 provides the reuse ID and the battery management information 30 to the reuse user in association with each other.

More specifically, the battery use system 500 includes an information collecting apparatus 510. The information collecting apparatus 510 is communicable with the information management system 300 via a wired or wireless communication network. The information management system 300 transmits the reuse ID and the battery management information 30 of the battery pack 10 to the information collecting apparatus 510 of the battery use system 500 in which the battery pack 10 is reused. The information collecting apparatus 510 manages the reuse ID and the battery management information 30 in association with each other. On the other hand, the reuse ID of the battery pack 10 is stored in the controller 12 in the battery pack 10. Therefore, in the battery use system 500, the battery pack 10, the reuse ID, and the battery management information 30 are associated with one another.

When the battery pack 10 is reused in the battery use system 500, the information collecting apparatus 510 monitors the status of use of the battery pack 10 and adds battery usage history information on the battery pack 10 to the battery management information 30 (battery information BAT). As a result, the battery management information 30 includes not only the battery information BAT when the battery pack 10 is primarily used in the vehicle 100 but also the battery information BAT when the battery pack 10 is reused in the battery use system 500.

The information collecting apparatus 510 periodically uploads the latest battery management information 30 to the information management system 300 together with the reuse ID. The information management system 300 periodically acquires the latest battery management information 30 and the reuse ID. The information management system 300 updates the battery management information 30 associated with the reuse ID in the battery management information database 330 with the latest one.

A user that desires to reuse a battery pack 10 is referred to as “reuse applicant”. A reuse applicant can be a reuse user in the future. The information management system 300 may provide the reuse ID and the battery management information 30 of a battery pack 10 to a reuse applicant. More specifically, a reuse applicant makes a request of the information management system 300 to provide information with the use of a terminal 400 (see FIG. 1). The information management system 300 provides the terminal 400 with pieces of battery management information 30 and reuse IDs of various battery packs 10. The reuse applicant is able to select a desired battery pack 10 (reuse ID) by viewing the pieces of battery management information 30 displayed on the terminal 400.

### 2. Provision of CFP Information

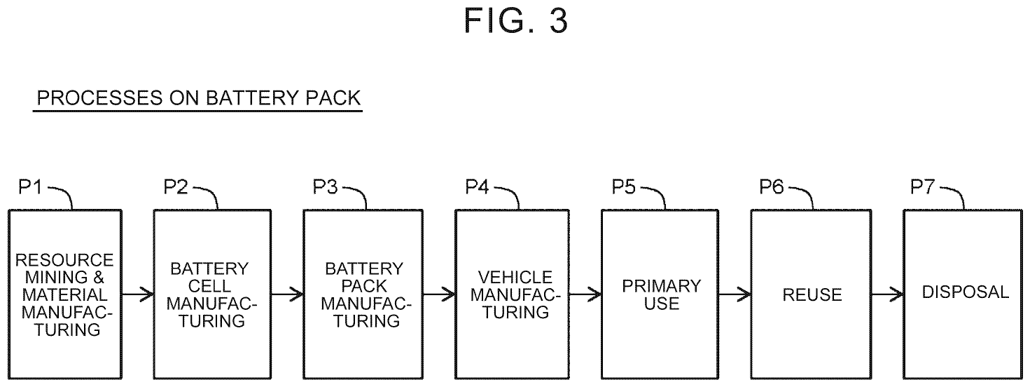

FIG. 3 is a diagram that shows processes P1, P2, P3, P4, P5, P6, and P7 related to a battery pack 10. The process P1 relates to mining of necessary resources to manufacture battery cells 11 included in a battery pack 10 and manufacturing of necessary materials for manufacturing the battery cells 11. The process P2 relates to manufacturing of the battery cells 11. The process P3 relates to manufacturing of the battery pack 10. Broadly speaking, the processes P1, P2, and P3 relate to manufacturing of the battery pack 10. The process P4 relates to manufacturing of a vehicle 100 on which the battery pack 10 is mounted. The process P5 relates to primary use of the battery pack 10 in the vehicle 100. The process P6 relates to the reuse of the battery pack 10 after the end of primary use. Reuse at least includes secondary use and can be further repeatedly used in some cases. The disposal process P7 relates to, for example, collection of the discarded battery pack 10 and various handlings of the collected battery pack 10. Examples of the various handlings include making the battery cells 11 harmless, and recycling to take out reusable materials from the battery cells 11. Depending on the battery pack 10, the reuse process P6 can be omitted.

In the above-described processes P1, P2, P3, P4, P5, P6, and P7, greenhouse gas, such as CO₂, is emitted or can be emitted. In the present embodiment, the information management system 300 corresponds to an example of the “information providing system” according to the disclosure. Therefore, in order to provide carbon footprint (CFP) information of the battery pack 10, the information management system 300 acquires (collects) a CO₂ emission amount converted from the amount of emission of greenhouse gas in each of the processes P1, P2, P3, P4, P5, P6, and P7 as CFP information. Then, the information management system 300 provides a requester with the CFP information in response to a request from the requester.

### 2-1. First Example

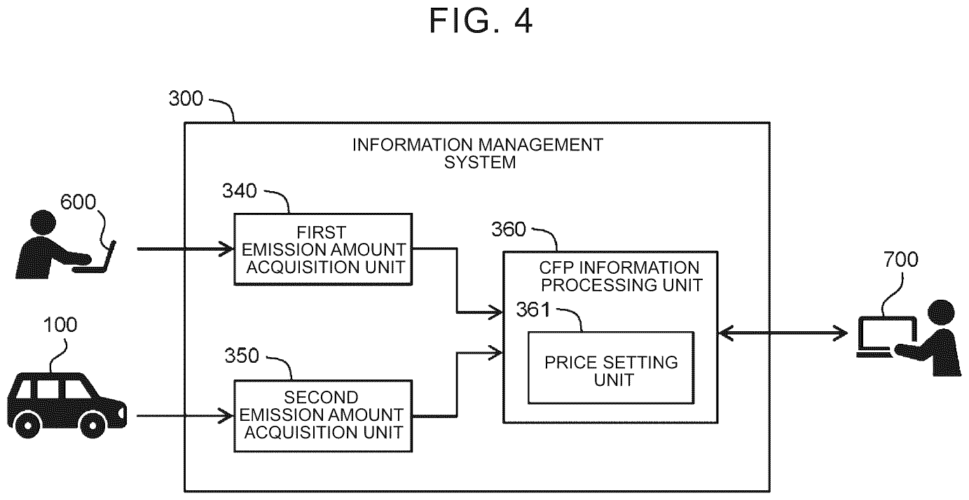

FIG. 4 is a block diagram that shows the functional configuration of a first example related to acquisition and provision of CFP information. The information management system 300 includes a first emission amount acquisition unit 340, a second emission amount acquisition unit 350, and a CFP information processing unit 360 that are implemented by the information processing device 310. CFP information acquired in the first example includes first CO₂ emission amount information and second CO₂ emission amount information.

### First Emission Amount Acquisition Unit

The first emission amount acquisition unit 340 acquires first CO₂ emission amount information and stores the acquired first CO₂ emission amount information in the storage device of the information processing device 310. The first CO₂ emission amount information is obtained by converting the amount of emission of greenhouse gas concerned with manufacturing of the battery pack 10 and the vehicle 100 into a CO₂ emission amount. The first CO₂ emission amount information includes, for example, the following CO₂ emission amounts A, B, C, and D. The CO₂ emission amount A is a total value of CO₂ emission amounts respectively emitted during resource mining and material manufacturing in the process P1. The CO₂ emission amount A may be, for example, calculated as a CO₂ emission amount per 1 kg of the material of the battery cell 11. The CO₂ emission amount B is a CO₂ emission amount emitted during manufacturing of the battery cell 11 in the process P2 and may be, for example, calculated as a CO₂ emission amount required to manufacture a battery cell 11. Alternatively, the CO₂ emission amount B may be calculated as a CO₂ emission amount required to manufacture a battery stack made up of a plurality of battery cells 11. The CO₂ emission amount C is a CO₂ emission amount emitted during manufacturing of the battery pack 10 in the process P3. The CO₂ emission amount D is a CO₂ emission amount emitted during manufacturing of the vehicle 100 in the process P4.

For example, the CO₂ emission amount A can be calculated based on a CO₂ emission amount during production of greenhouse gas and electric power used for resource mining and material manufacturing. Similarly, the CO₂ emission amount B can be calculated based on a CO₂ emission amount during production of greenhouse gas and electric power used to manufacture the battery cell 11. The CO₂ emission amount C can be calculated based on a CO₂ emission amount during production of greenhouse gas and electric power used to manufacture the battery pack 10. The CO₂ emission amount D can be calculated based on a CO₂ emission amount during production of greenhouse gas and electric power used to manufacture the vehicle 100. Additionally, each of the CO₂ emission amounts A, B, C, and D may include a CO₂ emission amount during transport of a corresponding one of the materials, the battery cell 11, the battery pack 10, and the vehicle 100 to a place where the next process is performed.

The above-described CO₂ emission amounts A, B, C, and D are calculated by, for example, business operators that are respectively in charge of the processes P1, P2, P3, and P4. Some of the business operators concerned with at least two processes of the process P1, the process P2, the process P3, and the process P4 may be the same (for example, a manufacturing business operator for the battery pack 10 and a manufacturing business operator for the vehicle 100). Then, as shown in FIG. 4, the first emission amount acquisition unit 340 communicates with individual terminals 600 of the business operators to acquire CO₂ emission amounts A, B, C, and D (that is, the first CO₂ emission amount information). Alternatively, in an example, in which the manufacturing business operator for the vehicle 100 acquires the upstream CO₂ emission amounts A, B, and C in advance, the first emission amount acquisition unit 340 communicates with the terminal 600 of the manufacturing business operator for the vehicle 100 to acquire the CO₂ emission amounts A, B, C, and D. Alternatively, the first emission amount acquisition unit 340 may acquire information that is a basis for calculating the CO₂ emission amounts A, B, C, and D from the business operators and calculate the CO₂ emission amounts A, B, C, and D based on the information in itself.

### Second Emission Amount Acquisition Unit

The second emission amount acquisition unit 350 acquires second CO₂ emission amount information and stores the acquired second CO₂ emission amount information in the storage device of the information processing device 310. The second CO₂ emission amount information is obtained by converting the amount of emission of greenhouse gas emitted during primary use (more specifically, during the entire period of primary use) of the battery pack 10 in the vehicle 100 into a CO₂ emission amount. Here, a method of calculating second CO₂ emission amount information will be described by way of a BEV and a PHEV as examples sequentially.

Initially, in an example of a BEV, a CO₂ emission amount E during production of electric power for charging the battery pack 10 with an external charger corresponds to the second CO₂ emission amount information. The CO₂ emission amount E is a product of a total amount of charging power (kWh) of the battery pack 10 during primary use and a CO₂ emission coefficient Ke. The CO₂ emission coefficient Ke is, for example, a CO₂ emission coefficient (t-CO₂/kWh) of electric power per unit amount of electric power. The total amount of charging power used to calculate a CO₂ emission amount E can be, for example, acquired as follows. In other words, in a case where the battery information BAT that can be acquired from the vehicle 100 includes a total charge electricity amount (Ah), the total amount of charging power can be acquired by dividing a product of the total charge electricity amount derived from the battery information BAT and a total voltage (V) of a main power supply for power by 1000. The total voltage of the main power supply for power may be, for example, a value released by the manufacturing business operator for the vehicle 100 (so-called catalog value). In a case where the battery information BAT includes a total amount of charging power itself, the total amount of charging power can be directly acquired from the battery information BAT. For example, a numeric value released every year by an external institution for each electric power supplier may be used as the CO₂ emission coefficient Ke. The storage device of the information processing device 310 stores data of the CO₂ emission coefficient Ke for each electric power supplier, acquired through communication with a server of an external institution.

The second emission amount acquisition unit 350, for example, calculates a product of one-year amount of charging power and the CO₂ emission coefficient Ke as the CO₂ emission amount E every year during primary use of the battery pack 10. Then, the second emission amount acquisition unit 350 adds up the CO₂ emission amount E of each year and calculates the CO₂ emission amount E that is a total during primary use as the second CO₂ emission amount information. Additionally, the CO₂ emission coefficient Ke decreases as the percentage of the amount of renewable energy generated (the percentage of renewable energy) in the amount of electric power generated by an electric power supplier that supplies electric power to an external charger increases. For example, when the percentage is 100%, the CO₂ emission coefficient Ke is zero, so the CO₂ emission amount E is also zero. For this reason, the CO₂ emission amount E may be calculated by using the CO₂ emission coefficient Ke that reflects the percentage. An electric power supplier that supplies electric power to an external charger can be identified based on the location information of the vehicle 100 being externally charged.

Alternatively, the second emission amount acquisition unit 350 may acquire the CO₂ emission amount E not every year and may acquire the CO₂ emission amount E each time the battery pack 10 is charged. In other words, at the end of charging, the second emission amount acquisition unit 350 may acquire information on a charge electricity amount and location information from the vehicle 100 and calculate a current value of the CO₂ emission amount E based on the acquired information. Then, the second emission amount acquisition unit 350 may update an accumulated value of the CO₂ emission amount E (that is, a second CO₂ emission amount) by adding the current value to the accumulated value until the last charging. Alternatively, the second emission amount acquisition unit 350 may calculate a CO₂ emission amount E based on information on the total amount of charging power acquired from the vehicle 100 at the end of primary use. The information processing device of the vehicle 100 may calculate the CO₂ emission amount E. In this example, the second emission amount acquisition unit 350 may, for example, communicate with the vehicle 100 at the end of primary use and acquire the CO₂ emission amount E from the vehicle 100.

Next, in an example of a PHEV, the sum of the above-described CO₂ emission amount E and the next CO₂ emission amount F corresponds to the second CO₂ emission amount information. A PHEV is capable of driving using only an electric motor without operating an internal combustion engine (BEV driving) and driving by cooperation between the internal combustion engine and the electric motor (HEV driving). The CO₂ emission amount E corresponds to a CO₂ emission amount in BEV driving, and the CO₂ emission amount F corresponds to a CO₂ emission amount in HEV driving. The CO₂ emission amount F is a product of a value obtained by dividing a travel distance DH (km) of the vehicle 100 using HEV driving by a fuel consumption rate Fe (km/L), and the CO₂ emission amount X per 1 L of fuel. For example, a value included in the travel history information TRV that can be acquired from the vehicle 100 may be used as the travel distance DH. For example, a value released by a manufacturing business operator for the vehicle 100 (so-called catalog value) may be used as the fuel consumption rate Fe. The CO₂ emission amount X can be acquired by, for example, communicating with the server of an external institution. The acquired fuel consumption rate Fe and CO₂ emission amount X are stored in the storage device of the information processing device 310.

The second emission amount acquisition unit 350 periodically communicates with the vehicle 100 during primary use to acquire the travel distance DH after last acquisition of data. The second emission amount acquisition unit 350 calculates a current value of the CO₂ emission amount F based on the acquired travel distance DH, fuel consumption rate Fe, and CO₂ emission amount X. Then, the second emission amount acquisition unit 350 updates an accumulated value of the CO₂ emission amount F by adding a current value to the accumulated value at the time of calculation of a last value of the CO₂ emission amount F. Then, the second emission amount acquisition unit 350 periodically calculates the sum of the separately calculated accumulated value of the CO₂ emission amount E and accumulated value of the CO₂ emission amount F and updates the second CO₂ emission amount information with the sum.

Alternatively, the CO₂ emission amount F may be calculated by using a total travel distance DH acquired from the vehicle 100 at the end of primary use. The CO₂ emission amount F may be calculated by the information processing device of the vehicle 100. In this example, the second emission amount acquisition unit 350 may, for example, communicate with the vehicle 100 at the end of primary use and acquire the CO₂ emission amount F from the vehicle 100.

Additionally, the second CO₂ emission amount information calculated as described above may include a CO₂ emission amount at the time of transporting the battery pack 10 detached from the vehicle 100 at the end of primary use to a place of reuse.

### CFP Information Processing Unit

In the first example, the CFP information processing unit 360 acquires the latest value of the first CO₂ emission amount information from the first emission amount acquisition unit 340 and the latest value of the second CO₂ emission amount information from the second emission amount acquisition unit 350 and manages the acquired latest values as CFP information. The CFP information processing unit 360 may, for example, individually manage the latest value of the first CO₂ emission amount information and the latest value of the second CO₂ emission amount information as CFP information. The CFP information to be managed may include a total value of the latest value of the first CO₂ emission amount information and the latest value of the second CO₂ emission amount information. Alternatively, the CFP information to be managed may be only the total value.

The information management system 300 is communicable with a terminal 700 that is used by a requester that desires to be provided with CFP information. The terminal 700 is, for example, a personal computer or a smartphone. The CFP information processing unit 360 provides CFP information via the terminal 700 to the requester that operates the terminal 700 in response to a request from the requester. Transmission of the CFP information to the requester or permission of access of the requester to the CFP information using the terminal 700 corresponds to an example of providing CFP information.

A requester is, for example, a secondary use applicant (reuse applicant) that desires to secondarily use a battery pack 10. In an example in which the requester is a secondary use applicant, the terminal 700 (see FIG. 4) is the same as the terminal 400 (see FIG. 1). Additionally, CFP information may be provided to the secondary use applicant together with the reuse ID and the battery management information 30 of the battery pack 10.

As shown in FIG. 4, the CFP information processing unit 360 may include a price setting unit 361. The price setting unit 361 sets the price of the battery pack 10 to be presented to a secondary use applicant according to CFP information. Specifically, the price may be, for example, set so as to increase as a numeric value of CFP information (a numeric value of at least one of the first CO₂ emission amount information and the second CO₂ emission amount information) decreases. More specifically, the second CO₂ emission amount information used to set the price covers the entire period of primary use. In an example of a BEV in which the CO₂ emission amount E corresponds to the second CO₂ emission amount information, the price may be set so as to increase as a value obtained by dividing the CO₂ emission amount E by the total amount of charging power of the battery pack 10 during primary use (that is, the CO₂ emission coefficient Ke) decreases. Similarly, in an example of a PHEV in which the sum of the CO₂ emission amount E and the CO₂ emission amount F correspond to the second CO₂ emission amount information as well, the price may be set in consideration of the fact that the price is increased as the CO₂ emission coefficient Ke decreases.

Alternatively, the requester may be, for example, a secondary use user (reuse user). The CFP information processing unit 360 may, for example, provide CFP information to a secondary use user in response to a request in advance after the secondary use user is determined as a destination to provide a battery pack 10. Alternatively, provision of CFP information may be performed in response to a request after the start of secondary use.

Alternatively, the requester may be, for example, a consumer. Here, a consumer is, for example, a user that owns another vehicle 100 of the same vehicle type as the vehicle 100 on which the battery pack 10 having CFP information to be provided, or a user that desires to purchase the another vehicle 100.

Additionally, provision of CFP information to a requester may be, for example, free or paid. Whether provision is free or paid may vary depending on a requester. In an example in which CFP information is periodically updated during primary use of the battery pack 10, the CFP information processing unit 360 may receive an application from a requester during primary use of the battery pack 10. Then, the CFP information processing unit 360 may provide a requester with CFP information including the latest second CO₂ emission amount at the timing of application by the requester.

### Advantageous Effects

According to the first example related to acquisition and provision of CFP information, the first CO₂ emission amount information during the period from resource mining to manufacturing of the vehicle 100 and the second CO₂ emission amount information during primary use can be provided to a requester as CFP information in response to a request.

Receiving provision of CFP information until primary use has the following advantage for a secondary use user and a secondary use applicant of the battery pack 10. In other words, in a case where CFP information until primary use is excellent, a business operator that secondarily uses the battery pack 10 can clearly call attention to society in constructing a low-carbon storage battery system using the battery pack 10 with a small CO₂ emission amount. In an example in which a manufacturing business operator for the vehicle 100 is a business operator that manages the information management system 300 (information providing system), providing CFP information in response to a request has the following advantage for the manufacturing business operator. In other words, in a case where CFP information is excellent, the manufacturing business operator can clearly call attention to society in that the low-carbon battery pack 10 is mounted on the vehicle 100 manufactured by itself.

With the price setting unit 361, the price of the battery pack 10 to be present to a secondary use applicant is set according to CFP information. For a business operator that secondarily uses the battery pack 10, excellent CFP information has the above-described advantage. Therefore, the battery pack 10 having excellent CFP information has a higher value than the battery pack 10 having not excellent CFP information. For this reason, by setting a price according to CFP information, dealing of the battery pack 10 at a further appropriate price reflecting a value based on the viewpoint of CFP information is facilitated.

### 2-2. Second Example

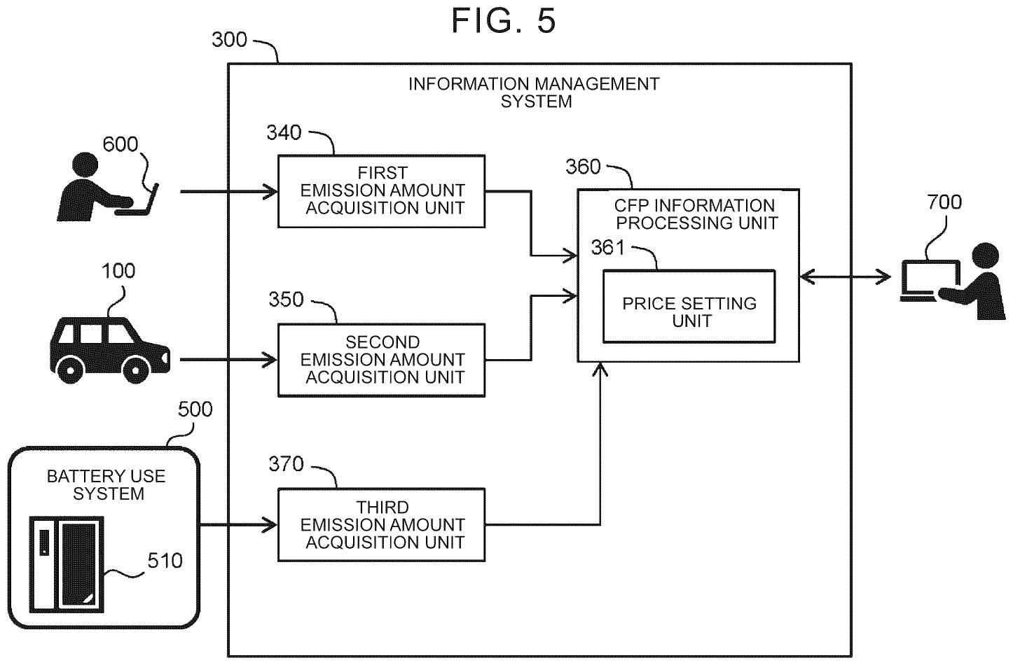

FIG. 5 is a block diagram that shows the functional configuration of a second example related to acquisition and provision of CFP information. The second example differs from the first example in that the information management system 300 additionally includes a third emission amount acquisition unit 370.

The third emission amount acquisition unit 370 acquires third CO₂ emission amount information and stores the acquired third CO₂ emission amount information in the storage device of the information processing device 310. The third CO₂ emission amount information is obtained by converting the amount of emission of greenhouse gas emitted during reuse of the battery pack 10 into a CO₂ emission amount.

Specifically, a CO₂ emission amount G during production of electric power for charging the battery pack 10 during reuse of the battery pack 10 corresponds to the third CO₂ emission amount information. A method of calculating the CO₂ emission amount G is, for example, similar to the above-described method of calculating the CO₂ emission amount E. In other words, the CO₂ emission amount G is, for example, a product of a total amount of charging power (kWh) of the battery pack 10 during reuse and a CO₂ emission coefficient Ke. The total amount of charging power (kWh) can be, for example, acquired from the battery management information 30 of the battery pack 10, periodically transmitted from the information collecting apparatus 510 of the battery use system 500. More specifically, even when the total amount of charging power is the same, the CO₂ emission amount G reduces as the above-described renewable energy percentage increases. The CO₂ emission amount G may be calculated by the information processing device of the battery use system 500. In this example, the third emission amount acquisition unit 370 may, for example, communicate with the battery use system 500 at the end of secondary use and acquire the CO₂ emission amount G from the battery use system 500.

Additionally, the third CO₂ emission amount information calculated as described above may include a CO₂ emission amount at the time of transporting the battery pack 10 from a place of secondary use to a place of tertiary use or disposal.

In the second example, the CFP information processing unit 360 acquires the latest value of the first CO₂ emission amount information from the first emission amount acquisition unit 340, the latest value of the second CO₂ emission amount information from the second emission amount acquisition unit 350, and the latest value of the third CO₂ emission amount information from the third emission amount acquisition unit 370 and manages the acquired latest values as CFP information. The CFP information processing unit 360 may, for example, individually manage the latest value of the first CO₂ emission amount information, the latest value of the second CO₂ emission amount information, and the latest value of the third CO₂ emission amount information as CFP information. The CFP information to be managed may include a total value of the latest value of the first CO₂ emission amount information, the latest value of the second CO₂ emission amount information, and the latest value of the third CO₂ emission amount information. Alternatively, the CFP information to be managed may be only the total value.

In an example in which tertiary use is performed after secondary use, the third emission amount acquisition unit 370, as in the case of the CO₂ emission amount G during secondary use, calculates a CO₂ emission amount H during tertiary use and adds the calculated CO₂ emission amount H to the third CO₂ emission amount information. This also applies to a case where reuse, such as quaternary use, is performed.

As for provision of CFP information until primary use, a requester in the second example is, for example, the same as the requester described for the first example. As for provision of only CFP information during secondary use (third CO₂ emission amount information) or total CFP information until secondary use, a requester may include the following person. In other words, in a case where tertiary use is performed after secondary use of the battery pack 10, a requester in the second example may be a secondary use applicant (reuse applicant) that desires tertiary use. As in the case of the example of the secondary use applicant, the price setting unit 361 may set the price of the battery pack 10 to be provided for a tertiary use applicant according to CFP information. Then, the requester may be, for example, a tertiary use user (reuse user). These also apply to a case where reuse, such as quaternary use, is performed.

According to the second example described above, it is possible to provide a requester with CFP information including the third CO₂ emission amount information together with the first CO₂ emission amount information and the second CO₂ emission amount information in response to a request.

As in the case of the example of secondary use, a business operator that tertiarily uses the battery pack 10 can also clearly call attention to society by receiving provision of CFP information until primary use or secondary use in constructing a low-carbon storage battery system. This also applies to a case where reuse, such as quaternary use, is performed.

### 2-3. Third Example

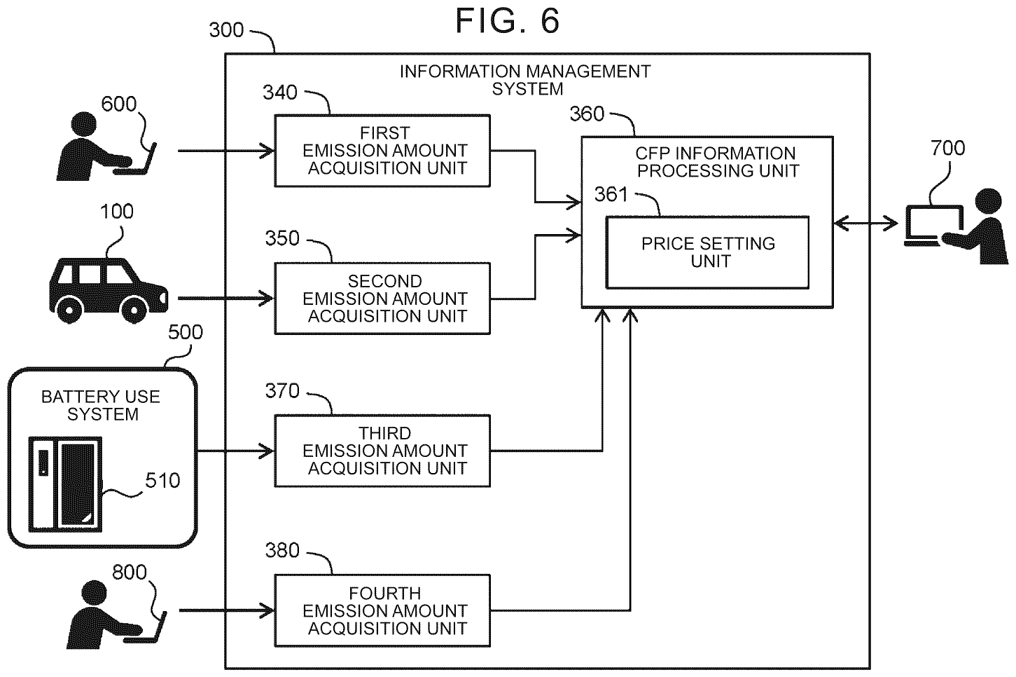

FIG. 6 is a block diagram that shows the functional configuration of a third example related to acquisition and provision of CFP information. The third example differs from the second example in that the information management system 300 additionally includes a fourth emission amount acquisition unit 380.

The fourth emission amount acquisition unit 380 acquires fourth CO₂ emission amount information and stores the acquired fourth CO₂ emission amount information in the storage device of the information processing device 310. The fourth CO₂ emission amount information is obtained by converting the amount of emission of greenhouse gas emitted during the disposal process P7 of the battery pack 10 into a CO₂ emission amount.

Specifically, a CO₂ emission amount I that is a total value of the CO₂ emission amounts respectively emitted at the time of collecting the battery pack 10 and the various handlings (such as recycling of the materials of the battery cells 11), included in the disposal process P7, corresponds to the fourth CO₂ emission amount information. For example, the CO₂ emission amount I can be calculated based on a CO₂ emission amount during production of greenhouse gas and electric power used for collection of the battery pack 10 and the various handlings. Additionally, the CO₂ emission amount I may include a CO₂ emission amount at the time of transporting recycled materials to a place where the next process (that is, the process P2 of manufacturing the battery cell 11 using the recycled materials) is performed.

The information management system 300 is communicable with one or more terminals 800 used by one or more business operators related to the disposal process P7 (see FIG. 3) of the battery pack 10. The fourth emission amount acquisition unit 380 communicates with the one or more terminals 800 to acquire the CO₂ emission amount I. Alternatively, the fourth emission amount acquisition unit 380 may acquire information that is a basis for calculating the CO₂ emission amount I from the one or more business operators and calculate the CO₂ emission amount I based on the information in itself.

In the third example, the CFP information processing unit 360 acquires the latest value of the first CO₂ emission amount information from the first emission amount acquisition unit 340, the latest value of the second CO₂ emission amount information from the second emission amount acquisition unit 350, the latest value of the third CO₂ emission amount information from the third emission amount acquisition unit 370, and the latest value of the fourth CO₂ emission amount information from the fourth emission amount acquisition unit 380 and manages the acquired latest values as CFP information. The CFP information processing unit 360 may, for example, individually manage the latest value of the first CO₂ emission amount information, the latest value of the second CO₂ emission amount information, the latest value of the third CO₂ emission amount information, and the latest value of the fourth CO₂ emission amount information as CFP information. The CFP information to be managed may include a total value of the latest value of the first CO₂ emission amount information, the latest value of the second CO₂ emission amount information, the latest value of the third CO₂ emission amount information, and the latest value of the fourth CO₂ emission amount information. Alternatively, the CFP information to be managed may be only the total value.

As for provision of CFP information until reuse, such as secondary use, a requester in the third example is, for example, the same as the requester described for the first and second examples. As for provision of CFP information of all the processes from the processes P1, P2, P3, P4, P5, P6, and P7, a requester may be, for example, a manufacturing business operator for the vehicle 100 in a case where a business operator different from the manufacturing business operator for the vehicle 100 manages the information management system 300 (information providing system). As for provision of only CFP information of the disposal process P7 (fourth CO₂ emission amount information), a requester may be, for example, a reuse user having reused the battery pack 10 proceeding to the disposal process P7.

According to the third example described above, it is possible to provide a requester with CFP information including the fourth CO₂ emission amount information together with the first CO₂ emission amount information, the second CO₂ emission amount information, and the third CO₂ emission amount information in response to a request.

In an example in which a manufacturing business operator for the vehicle 100 is a business operator that manages the information management system 300 (information providing system), collecting the total of the first CO₂ emission amount information to the fourth CO₂ emission amount information from resource mining to disposal as CFP information in a state being ready for provision has the following advantage. In other words, a manufacturing business operator for the vehicle 100 can clearly call attention in addressing low-carbonization by itself and social contribution. In an example in which a manufacturing business operator for the vehicle 100 is different from a business operator that manages the information management system 300, providing total CFP information from resource mining to disposal by the information management system 300 has the following advantage for the manufacturing business operator. In other words, a manufacturing business operator for the vehicle 100 is able to acquire insufficient CO₂ emission amount information (for example, the fourth CO₂ emission amount information) from the information management system 300 and keep track of total CFP information from resource mining to disposal. Then, the manufacturing business operator can clearly call attention by using the CFP information in addressing low-carbonization by itself and social contribution.

What is claimed is:

1. An information providing system that provides carbon footprint information of a battery pack mounted on a vehicle, the information providing system comprising one or more processors, the one or more processors being configured to:
acquire the carbon footprint information including first CO₂ emission amount information and second CO₂ emission amount information, the first CO₂ emission amount information being obtained by converting an amount of emission of greenhouse gas concerned with manufacturing the battery pack and the vehicle into a CO₂ emission amount, the second CO₂ emission amount information being obtained by converting an amount of emission of greenhouse gas emitted during primary use of the battery pack in the vehicle into a CO₂ emission amount; and
provide a requester with the carbon footprint information in response to a request from the requester.

2. The information providing system according to claim 1, wherein the carbon footprint information further includes third CO₂ emission amount information obtained by converting an amount of emission of greenhouse gas emitted during reuse of the battery pack into a CO₂ emission amount.

3. The information providing system according to claim 1, wherein the requester includes a user that reuses the battery pack or a user that desires to reuse the battery pack.

4. The information providing system according to claim 1, wherein:
the requester is a user that desires to reuse the battery pack; and
the one or more processors are configured to set a price of the battery pack to be presented to the user in response to the carbon footprint information.

5. The information providing system according to claim 1, wherein the carbon footprint information further includes fourth CO₂ emission amount information obtained by converting an amount of emission of greenhouse gas emitted in a disposal process of the battery pack into a CO₂ emission amount.
